(19) United States
(12) Patent Application Publication
(10) Pub. No.: US 2026/0333380 A1
(43) Pub. Date: Oct. 22, 2026

(54) CONTROL CHANNEL AUTHENTICATION BASED ON A USER AUTHENTICATION CODE (UAC)

(71) Applicant: Lenovo (United States) Inc., Morrisville, NC (US)

(72) Inventors: Hyejung Jung, Palatine, IL (US); Razvan-Andrei Stoica, Essen (DE); Vijay Nangia, Woodridge, IL (US)

(73) Assignee: Lenovo (United States) Inc., Morrisville, NC (US)

(21) Appl. No.: 19/380,537

(22) Filed: Nov. 5, 2025

(51) Int. Cl. H04W 72/232; H04W 12/037; H04W 12/06

(52) U.S. Cl. CPC H04W 72/232; H04W 12/037; H04W 12/06

(57) ABSTRACT

Various aspects of the present disclosure relate to physical downlink channel (PDCCH) authentication based on a user authentication code (UAC). An apparatus, such as a user equipment (UE), receives information indicating a temporary UE identifier (ID) and at least one search space configuration. The UE decodes channel bits associated with a PDCCH candidate of a search space set, where the search space set corresponds to the at least one search space configuration. The UE authenticates the PDCCH candidate based on an expected UAC and the decoded channel bits, the UAC based on the temporary UE ID. Additionally, a network equipment (NE) transmits a PDCCH associated with DCI and a UAC that is based on the temporary UE ID. The UE verifies that the PDCCH candidate is intended for the UE if the UACs match.

### TECHNICAL FIELD

The present disclosure relates to wireless communications, and more specifically to authenticating control channel based on a user authentication code (UAC).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive information indicating a temporary UE identifier (ID) and at least one search space configuration; decode one or more channel bits associated with a physical downlink control channel (PDCCH) candidate of a search space set, wherein the search space set corresponds to the at least one search space configuration; and authenticate the PDCCH candidate for the UE based on an expected UAC and the decoded channel bits, wherein the expected UAC is based on the temporary UE ID.

A processor (e.g., a standalone processor chipset, or a component of a UE) for wireless communication is described. The processor may be configured to, capable of, or operable to perform one or more operations as described herein. For example, the processor may be configured to, capable of, or operable to receive information indicating a temporary UE ID and at least one search space configuration; decode one or more channel bits associated with a PDCCH of a search space set, wherein the search space set corresponds to the at least one search space configuration; and authenticate the PDCCH candidate for the UE based on an expected UAC and the decoded channel bits, wherein the expected UAC is based on the temporary UE ID.

A method performed or performable by a UE for wireless communication is described. The method may include receiving information indicating a temporary UE ID and at least one search space configuration; decoding one or more channel bits associated with a PDCCH of a search space set, wherein the search space set corresponds to the at least one search space configuration; and authenticating the PDCCH candidate for the UE based on an expected UAC and the decoded channel bits, wherein the expected UAC is based on the temporary UE ID.

In some implementations of the UE, the processor, and the method described herein, the UE, the processor, and the method may further be configured to, capable of, operable to, performed to, or performable to generate the expected UAC based at least in part on the temporary UE ID. In some implementations of the UE, the processor, and the method described herein, the information further indicates a cipher key, and where the at least one processor is further operable to cause the UE to decrypt encrypted downlink control information (DCI) associated with the decoded channel bits based on the cipher key.

In some implementations of the UE, the processor, and the method described herein, the UE, the processor, and the method may further be configured to, capable of, operable to, performed to, or performable to identify a UAC based on the decoded channel bits; and verify that the expected UAC matches the identified UAC, where the encrypted DCI is decrypted based on the expected UAC matching the identified UAC.

In some implementations of the UE, the processor, and the method described herein, the at least one processor is further operable to cause the UE to generate the expected UAC based on the encrypted DCI; and verify the encrypted DCI based on the expected UAC and the identified UAC.

In some implementations of the UE, the processor, and the method described herein, the at least one processor is further operable to cause the UE to generate the expected UAC based on the decrypted DCI; and verify the decrypted DCI based on the expected UAC and a UAC identified based at least in part on decryption of the decoded channel bits.

In some implementations of the UE, the processor, and the method described herein, to decrypt the encrypted DCI, the UE, the processor, and the method may further be configured to, capable of, operable to, performed to, or performable to decrypt one or more cyclic redundancy check (CRC) bits associated with the encrypted DCI; generate one or more expected CRC bits based on the decrypted DCI; and determine whether the DCI is successfully detected based on the expected CRC bits, the decrypted CRC bits, and a determination that the PDCCH candidate is authenticated for the UE.

In some implementations of the UE, the processor, and the method described herein, the UE, the processor, and the method may further be configured to, capable of, operable to, performed to, or performable to identify one or more CRC bits from the decoded channel bits based on descrambling at least a portion of the decoded channel bits of a first length with at least a portion of the expected UAC of the first length; generate one or more expected CRC bits based on the encrypted DCI; and determine whether the DCI is successfully detected based on the expected CRC bits and the identified CRC bits.

In some implementations of the UE, the processor, and the method described herein, the information further indicates a user authentication key, and the UE, the processor, and the method may further be configured to, capable of, operable to, performed to, or performable to generate the expected UAC based on the temporary UE ID and the user authentication key. In some implementations of the UE, the processor, and the method described herein, the UE, the processor, and the method may further be configured to, capable of, operable to, performed to, or performable to generate the expected UAC based on search space-related information included in the at least one search space configuration, where the search space-related information includes one or more of a search space identity, a PDCCH monitoring occasion (PMO) index, or a lowest control channel element (CCE) index for the PDCCH candidate.

In some implementations of the UE, the processor, and the method described herein, the UE, the processor, and the method may further be configured to, capable of, operable to, performed to, or performable to demodulate one or more resource elements (REs) corresponding to the PDCCH candidate based on one or more demodulation reference signal (DMRS) REs and a DMRS sequence associated with the PDCCH candidate, where the DMRS sequence is based on one or more of a hashing function, the temporary UE ID, a scrambling identity, or search space-related information included in the at least one search space configuration.

In some implementations of the UE, the processor, and the method described herein, the UE, the processor, and the method may further be configured to, capable of, operable to, performed to, or performable to descramble the one or more channel bits according to a scrambling sequence, where the scrambling sequence is based on one or more of a hashing function, the temporary UE ID, a scrambling identity, or search space-related information included in the at least one search space configuration, and where decoding the one or more channel bits includes decoding the descrambled channel bits.

In some implementations of the UE, the processor, and the method described herein, the information is received via one or more of an encrypted and integrity-protected non-access stratus (NAS) message, an encrypted and integrity-protected radio resource control (RRC) message, or an encrypted and integrity-protected medium access control (MAC) control element (CE).

An NE (e.g., a base station) for wireless communication is described. The NE may be configured to, capable of, or operable to perform one or more operations as described herein. For example, the NE may be configured to, capable of, or operable to transmit information indicating a temporary UE ID and at least one search space configuration; and transmit a PDCCH associated with DCI and a UAC on one or more REs corresponding to a PDCCH candidate of a search space set, where the search space set corresponds to the at least one search space configuration, and where the UAC is based on the temporary UE ID.

A processor (e.g., a standalone processor chipset, or a component of a NE) for wireless communication is described. The processor may be configured to, capable of, or operable to perform one or more operations as described herein. For example, the processor may be configured to, capable of, or operable to transmit information indicating a temporary UE ID and at least one search space configuration; and transmit a PDCCH associated with DCI and a UAC on one or more REs corresponding to a PDCCH candidate of a search space set, where the search space set corresponds to the at least one search space configuration, and where the UAC is based on the temporary UE ID.

A method performed or performable by an NE (e.g., a base station) for wireless communication is described. The method may include transmitting information indicating a temporary UE ID and at least one search space configuration; and transmitting a PDCCH associated with DCI and a UAC on one or more REs corresponding to a PDCCH candidate of a search space set, where the search space set corresponds to the at least one search space configuration, and where the UAC is based on the temporary UE ID.

In some implementations of the NE, the processor, and the method described herein, the information further indicates a cipher key, and where the at least one processor is further operable to cause the NE to encrypt the DCI based on the cipher key. In some implementations of the NE, the processor, and the method described herein, to encrypt the DCI, the NE, the processor, and the method may further be configured to, capable of, operable to, performed to, or performable to generate one or more CRC bits associated with the DCI; and encrypt the one or more CRC bits.

In some implementations of the NE, the processor, and the method described herein, the information further indicates a user authentication key, and where the UAC is generated based on the temporary UE ID and the user authentication key.

In some implementations of the NE, the processor, and the method described herein, the UAC is generated based on search space-related information included in the at least one search space configuration, where the search space-related information includes one or more of a search space identity, a PMO index, or a lowest CCE index for the PDCCH candidate.

### BRIEF DESCRIPTION OF THE DRAWINGS

FIG. 1 illustrates an example of a wireless communications system in accordance with aspects of the present disclosure.

FIGS. 2 and 3 illustrate examples of flow diagrams for generating a PDCCH in accordance with aspects of the present disclosure.

FIG. 4 illustrates an example of a PMO configuration in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In some wireless communication systems, such as 5G New Radio (NR) networks, an NE may transmit a PDCCH carrying DCI to a UE, where the DCI may include various types of control information. For a UE-specific PDCCH (e.g., a PDCCH monitored in a UE-specific search space), channel bits of the PDCCH may be scrambled based on a cell-radio network temporary identifier (C-RNTI) and, if configured, a PDCCH DMRS scrambling identifier associated with (e.g., assigned by the NE to) a UE. This scrambling may ensure that only a UE with the C-RNTI and/or PDCCH DMRS scrambling identifier may receive and decode the PDCCH and obtain corresponding DCI. In addition, flexible resource allocation of a control resource set (CORESET), flexible numerology and beamforming for the PDCCH may further enhance privacy of DCI delivery.

Although scrambling and other protective measures in these wireless communications systems (e.g., 5G NR systems) provide a degree of security for transmission of PDCCH, a UE-specific PDCCH may still be susceptible to security attacks due to increasing computing capabilities of attackers (e.g., a malicious UE, an unauthorized UE, or a rogue NE) and the relatively small number of possible RNTI and DMRS identifiers (e.g., values). When an attacker successfully decodes PDCCHs intended for a particular UE, the attacker may monitor traffic patterns associated with the UE and infer application usage types. In some cases, the attacker may modify contents of the DCI and transmit the modified DCI, potentially trigger unauthorized uplink transmissions by the UE, such as a random access procedure or bandwidth part (BWP) switching.

Aspects of the present disclosure are described in the context of a wireless communications system, and include implementations that provide methods for PDCCH transmission and reception with privacy and integrity protection. In one or more implementations, an NE (e.g., a gNB, a network entity, a base station) may transmit (i.e., send) information regarding one or more of a temporary UE ID, a search space configuration, a cipher key, or a user authentication key to a particular UE using privacy and integrity protection. That is, the information may be encrypted or otherwise processed through an algorithm that adds security to the transmission. In some cases, the NE may encrypt DCI intended for the UE based on the cipher key. Additionally, the NE may generate a UAC based on the temporary UE ID and the search space configuration (e.g., which may include a PMO index). In some examples, the NE may support a UAC generator to generate the UAC based on an integrity algorithm or a hash function such as a secure hash algorithm (SHA).

In some cases, the UE may generate its own expected UAC. In response to receiving the UAC from the NE, the UE may compare the generated expected UAC with the received UAC to determine whether the received UAC is intended for the UE. If the generated and received UACs match, then the received UAC (and corresponding DCI) are intended for the UE. In some implementations, a pseudo-random sequence used for scrambling channel bits of a PDCCH (e.g., a scrambling sequence), a DMRS sequence of the PDCCH, or both may be generated based on an output of hashing the temporary UE ID and a configured scrambling identity, and by selection of the output bits based on the search space configuration.

By performing the described techniques, a device in a wireless communications system can improve the privacy and security of PDCCH and DCI transmissions and receptions. In some other systems (e.g., 3GPP systems), DCI is not encrypted, and because CRC parity bits of the DCI are scrambled with an RNTI, an attacker may be able to identify traffic patterns and corresponding applications of a particular UE associated with the RNTI. In contrast, using the described techniques, a UE may determine whether a PDCCH candidate is intended for the UE based on a UAC included in the PDCCH. Since the UAC may be generated based on a UE ID and using hashing or some other integrity algorithm, the actual UE ID may be concealed in the PDCCH, improving privacy and security of the transmission. Moreover, UE-specific search space information (i.e., a search space configuration) may be securely communicated via a RRC message and used to generate a time-varying UAC, which may further enhance privacy protection for the PDCCH. In addition, an information bit size of the protected PDCCH may be maintained similarly to how an information bit size of a PDCCH may be maintained if at least a part of the UAC is used to scramble CRC bits. Alternatively, if the UAC is also based on DCI, the UE may check the integrity of (e.g., authorize) the received DCI based on the UAC and accordingly, omit the CRC, which may improve efficiency and reduce latency.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

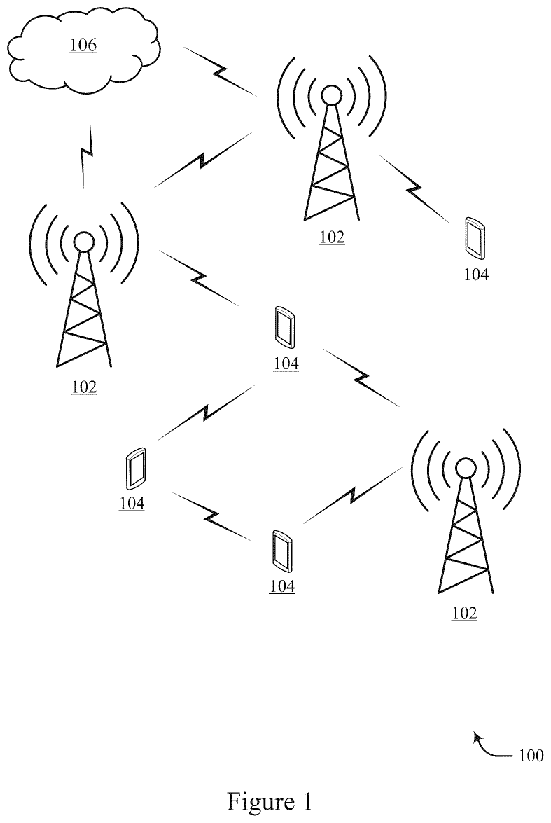

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHZ-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, DCI may include various information such as one or more of a downlink resource assignment, an uplink grant, a slot format, available resource block (RB) sets, a channel occupancy time (COT) duration, search space set group switching, time and frequency resources during which a UE 104 may assume no transmission is intended for the UE 104, availability of soft resources for integrated access-backhaul mobile termination (IAB-MT), power saving information outside a discontinuous reception (DRX) Active Time for one or more UEs 104, a paging early indication, tracking reference signal (TRS) availability indication, an aperiodic beam indication and associated time resources for a network controlled repeater (NCR), activation or deactivation of a cell discontinuous transmission (DTX) and/or a DRX configuration of one or multiple serving cells for one or more UEs 104, or a network energy saving (NES)-mode indication of a primary cell for one or more UEs 104. Additionally, a PDCCH may include one or more control channel elements (CCEs), such as the CCEs indicated in Table 1.

TABLE 1
Supported PDCCH aggregation levels.

| Aggregation level | Number of CCEs |
|---|---|
| 1 | 1 |
| 2 | 2 |
| 4 | 4 |
| 8 | 8 |
| 16 | 16 |

In some implementations, a CORESET may include

$${N}_{R B}^{CORESET}$$

RBS in a frequency domain and

$${N}_{s y m b}^{CORESET}$$

∈{1, 4, 5} symbols in a time domain. A CCE may include six resource element groups (REGs), where an REG may be equal to one RB during one OFDM symbol. REGs within a CORESET may be numbered in increasing order in a time-first manner, starting with 0 for a first OFDM symbol and the lowest-numbered RB in the CORESET. A UE 104 may be configured with multiple CORESETs, where each CORESET may be associated with one CCE-to-REG mapping. The CCE-to-REG mapping for a CORESET may be interleaved or non-interleaved, and may be described by REG bundles. For example, an REG bundle i may be defined as REGs {iL, iL+1, . . . , iL+L−1}, where L may be the REG bundle size,

$$i = 0 , 1 , … , {N}_{REG}^{CORESET} / L - 1 ,$$

and

$${N}_{REG}^{CORESET} = {N}_{R B}^{CORESET} {N}_{s y m b}^{CORESET}$$

may be the number of REGs in the CORESET. In addition, CCE j may include REG bundles {f(6j/L), f(6j/L+1), . . . , f(6j/L+6/L−1)}, where f(.) may be an interleaver.

For each CORESET, the UE 104 may be provided various parameters via a ControlResourceSet information element (IE). For example, the ControlResourceSet IE may include one or more or a CORESET index p, a DMRS scrambling sequence initialization value by pdcch-DMRS-ScramblingID, a precoder granularity for a number of REGs in the frequency domain, a number of consecutive symbols

$${N}_{s y m b}^{CORESET}$$

provided by duration, where

$${N}_{s y m b}^{CORESET} = 3$$

is supported only if the higher-layer parameter dmrs-TypeA-Position equals ‘pos3,’ a set of RBs including a number of

$${N}_{R B}^{CORESET}$$

provided by frequencyDomainResources, CCE-to-REG mapping parameters (interleaved or non-interleaved mapping) provided by cce-REG-MappingType, an antenna port quasi co-location (QCL), from a set of antenna port QCLs provided by TCI-State, indicating QCL information of the DMRS antenna port for PDCCH reception, or an indication for a presence or absence of a transmission configuration indication (TCI) field for a DCI format, other than DCI format 1_0, that schedules physical downlink shared channel (PDSCH) receptions or has associated hybrid automatic repeat request (HARQ)-acknowledgment (ACK) information without scheduling PDSCH and is provided by a PDCCH in CORESET p, by tci-PresentInDCI. For the precoder granularity for the number of REGs in the frequency domain, if the higher-layer parameter precoderGranularity equals same AsREG-bundle, the UE 104 may assume the same precoding being used within a REG bundle. Alternatively, if the higher-layer parameter precoderGranularity equals allContiguousRBs, the UE 104 may assume the same precoding being used across the all REGs within the set of contiguous RBs in the CORESET. Alternatively, the UE 104 may assume that no resource elements (REs) in the CORESET overlap with an synchronization signal block (SSB) and physical broadcast channel (PBCH) block.

For each CORESET in a downlink BWP of a serving cell, a respective frequencyDomainResources parameter may provide a bitmap. If a CORESET is not associated with any search space set configured with a parameter freqMonitorLocations, the bits of the bitmap may have a one-to-one mapping with non-overlapping groups of 6 consecutive physical resource blocks (PRBs), in ascending order of the PRB index in the downlink BWP bandwidth of

$${N}_{R B}^{BWP}$$

PRBS with a starting common RB position

$${N}_{B W P}^{start} .$$

The first common RB of the first group of 6 PRBs may have a common RB index of

$$6 \cdot ⌈ {N}_{B W P}^{start} / 6 ⌉$$

if rb-Offset may not be provided or the first common RB of the first group of 6 PRBs may have a common RB index

$${N}_{B W P}^{s t a r t} + {N}_{R B}^{offset}$$

where

$${N}_{R B}^{offset}$$

may be provided by rb-Offset.

In some examples, the UE 104 may assume a block of channel bits is scrambled and is quadrature phase-shift key (QPSK) modulated, resulting in a block of complex-valued modulation symbols. The block of complex-valued symbol may be scaled, mapped to REs for a monitored PDCCH, and not used for a PDCCH DMRS in increasing order of frequency first, then time.

Regarding PDCCH search space sets, the UE 104 may monitor a set of PDCCH candidates in one or more CORESETS on an active downlink BWP on each activated serving cell configured with PDCCH monitoring according to corresponding search space sets. Monitoring may imply receiving each PDCCH candidate and decoding the PDCCH candidates according to monitored DCI formats. A PDCCH search space set may be a common search space (CSS) set or a UE-specific search space (USS) set. A USS set may be configured by IEs SearchSpace with a parameter searchSpaceType=ue-Specific for DCI formats with CRC scrambled by a C-RNTI, modulation and coding scheme (MCS)-C-RNTI, semi-persistent (SP)-channel state information (CSI)-RNTI, or configured scheduling (CS)-RNTIs. DCI formats with CRC scrambled by C-RNTI, CS-RNTI, or MCS-C-RNTI may also be referred to as unicast DCI formats.

If the UE 104 has not been provided a Type3-PDCCH CSS set, or a Type1A-PDCCH CSS set, or a USS set and the UE 104 has received a C-RNTI and has been provided a Type1-PDCCH CSS set, the UE 104 may monitor PDCCH candidates for DCI format 0_0 and DCI format 1_0 with CRC scrambled by the C-RNTI in the Type1-PDCCH CSS set. Alternatively, if the UE 104 is provided one or more search space sets via one or more corresponding parameters (e.g., one or more of searchSpaceZero, searchSpaceSIB1, searchSpaceOtherSystemInformation, pagingSearchSpace, or ra-SearchSpace), and the UE 104 is provided a C-RNTI, an MCS-C-RNTI, or a CS-RNTI, then the UE 104 may monitor PDCCH candidates for DCI format 0_0 and DCI format 1_0 with CRC scrambled by the C-RNTI, the MCS-C-RNTI, or the CS-RNTI in the one or more search space sets in a slot, where the UE 104 may monitor PDCCH candidates for at least a DCI format 0_0 or a DCI format 1_0 with CRC scrambled by SI-RNTI, a random access (RA)-RNTI, a Message B (MsgB)-RNTI, or a paging (P)-RNTI.

If a UE 104 is provided with one or more search space sets via one or more corresponding parameters (e.g., one or more of searchSpaceZero, searchSpaceSIB1, searchSpaceOtherSystemInformation, pagingSearchSpace, pei-SearchSpace, ra-SearchSpace), or a CSS set (e.g., by PDCCH-Config), and if the UE 104 is provided with an SI-RNTI, a P-RNTI, a paging early indication (PEI)-RNTI, an RA-RNTI, a MsgB-RNTI, a slot format indicator (SFI)-RNTI, an interruption (INT)-RNTI, a transmit power control (TPC)-PUSCH-RNTI, a TPC-PUCCH-RNTI, or a TPC-SRS-RNTI, then for an RNTI from any of the aforementioned RNTIs, the UE 104 may not expect to process information from more than one DCI format with CRC scrambled with the RNTI per slot.

Regarding activation of access stratum (AS) security, in response to RRC connection establishment for a UE 104, an NE 102 may initiate a security mode command procedure to the UE in an RRC CONNECTED state to activate AS security, where the procedure is applied when only signaling radio bearer (SRB) 1 is established (e.g., prior to establishment of other radio bearers, such as SRB2, multicast radio bearers (MRBs), data radio bearers (DRBs), or a combination thereof). Based on reception of a SecurityModeCommand IE, the UE 104 may derive a KgNB key and a KRRCint key associated with an integrityProtAlgorithm indicated in the SecurityModeCommand message. The UE 104 may verify the integrity protection of the SecurityModeCommand message using the indicated algorithm and the derived KRRCint key. If the SecurityModeCommand passes an integrity protection check, then the UE 104 may derive a KRRCenc key and a KUpenc key associated with a cipheringAlgorithm indicated in the SecurityModeCommand message. Additionally, the UE 104 may derive the KUPint key associated with the integrityProtAlgorithm indicated in the SecurityModeCommand message. The UE 104 may immediately apply SRB integrity protection using the indicated integrity protection algorithm and the KRRCint key, including the SecurityModeComplete message. The UE 104 may apply SRB ciphering using the indicated cyphering algorithm and the KRRCenc key after completing the procedure. With AS security being activated, the integrity protection for both RRC messages and user plane data may help to prevent tampering and replay attacks, and encryption of RRC signaling and user plane data protects may protect UEs 104 from eavesdropping that may occur over a radio link. Alternatively, if the SecurityModeCommand message fails the integrity protection check, the UE 104 may apply neither integrity protection nor ciphering.

According to implementations, one or more of the NEs 102 and the UEs 104 are operable to implement various aspects of the techniques described with reference to the present disclosure. For example, an NE 102 (e.g., a gNB, a network entity, a base station) may transmit (i.e., send) information regarding one or more of a temporary UE ID, a search space configuration, a cipher key, or a user authentication key to a particular UE 104 using privacy and integrity protection. That is, the information may be encrypted or otherwise processed through an algorithm that adds security to the transmission. In some cases, the NE 102 may encrypt DCI intended for the UE 104 based on the cipher key. Additionally, the NE 102 may generate a UAC based on the temporary UE ID and the search space configuration (e.g., which may include a PMO index). In some examples, the NE 102 may support a UAC generator to generate the UAC based on an integrity algorithm or a hash function such as an SHA.

In some cases, the UE 104 may generate its own expected UAC. In response to receiving the UAC from the NE 102, the UE 104 may compare the generated expected UAC with the received UAC to determine whether the received UAC is intended for the UE 104. If the generated and received UACs match, then the received UAC (and corresponding DCI) are intended for the UE 104. In some implementations, a pseudo-random sequence used for scrambling channel bits of a PDCCH (e.g., a scrambling sequence), a DMRS sequence of the PDCCH, or both may be generated based on an output of hashing the temporary UE ID and a configured scrambling identity, and by selection of the output bits based on the search space configuration.

Specifically, a UE may receive information indicating a temporary UE ID and at least one search space configuration. In some examples, the information may also indicate one or more of a cipher key or a user authentication key. The UE may demodulate one or more REs corresponding to a PDCCH candidate of a search space set that corresponds to the at least one search space configuration. The UE may decode one or more channel bits associated with a PDCCH candidate of a search space set, where the search space set corresponds to the at least one search space configuration and generate an expected UAC based on the temporary UE ID. Additionally, an NE may generate a UAC based on the temporary UE ID. The NE may transmit a PDCCH associated with DCI and the UAC on one or more REs corresponding to the PDCCH candidate of the search space set. The UE may compare the UACs generated by the UE and the NE and authenticate the PDCCH candidate for the UE (e.g., verify that the PDCCH candidate is intended for the UE) based on the UACs matching.

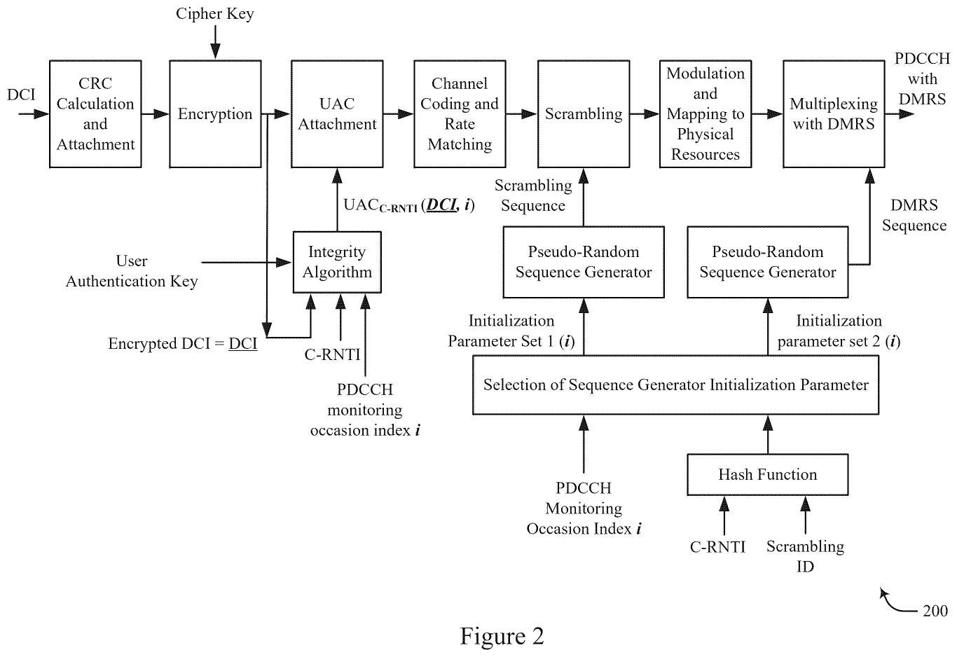

FIG. 2 illustrates an example of a flow diagram 200 in accordance with aspects of the present disclosure. The flow diagram 200 may represent an exemplary method for generating a PDCCH with privacy and integrity protection.

In some implementations, the flow diagram 200 may be utilized for communication of a UE-specific PDCCH with privacy protection. To provide such privacy protection, DCI may be encrypted based on physical-layer symmetric keys, which may be established or shared when higher-layer encryption (e.g., RRC/packet data convergence protocol (PDCP)) keys are set up. In some implementations, the physical-layer keys may be relatively smaller sized keys (e.g., 64-bit key length) than the higher-layer keys (e.g., 256-bit key length) to enable fast decryption. Alternatively, the physical-layer keys may be of a same size (e.g., 256-bit key length) or a larger size than the higher-layer keys. Such cases may leverage strong ciphers with cryptographic hardware acceleration support, such as an AES-256 symmetric cipher).

To receive DCI, the UE may blindly decode PDCCH candidates according to a configured number of PDCCH candidates per CCE aggregation level in each configured PDCCH search space set. The UE may determine whether a PDCCH candidate is intended for the UE by using a UAC included in a PDCCH. The UAC may be generated based on a UE ID, such as an RNTI, associated with the UE. Since the UAC is generated based on the UE ID via hashing or some other integrity algorithm, and as the UAC is time-varying (e.g., changes over time), the identity of the UE may be concealed in the PDCCH, thus protecting the privacy of the PDCCH.

In some implementations, the NE may transmit information including one or more of a temporary UE ID, a search space configuration, a cipher key, an integrity protection key, or a user authentication key to the UE. The NE may transmit the information with privacy and integrity protection, which may include transmitting the information via one or more of an encrypted and integrity protected NAS message, an encrypted and integrity protected RRC message, or an encrypted and integrity protected MAC-CE. In some examples, the temporary UE ID may include a C-RNTI of 16 bits. Alternatively, the UE ID may include a post-quantum cryptography (PQC)-C-RNTI (i.e., a C-RNTI protected by a post-quantum safe cipher), which may be an output of a PQC encryption function, or alternatively, cipher (e.g., AES-256, CRYSTALS-Kyber, Classic McEliece scheme based on McEliece Linear Block Error Correcting Codes, or the like), and may be longer than a C-RNTI.

In some examples, the NE may transmit information (e.g., an indication) to the UE about one or more of a ciphering algorithm, an integrity protection algorithm, or a user authentication algorithm, and in some cases, additional assistance information based on which the UE may derive one or more of the cipher key, the integrity protection key, or the user authentication key. The NE may encrypt DCI intended for a particular UE based on the cipher key. Additionally, or alternatively, the NE may protect the integrity of the DCI based on an integrity protection key.

Using a UAC generator at the NE, the NE may generate a UAC based on the temporary UE ID. In some examples, the NE may indicate whether any one or more of encryption, ciphering, or integrity protection is applied to the DCI via a PDCCH configuration, the search space configuration, or both. In some implementations, the UAC generator at the NE may be equipped with an in integrity algorithm, and the NE may use the integrity algorithm to generate the UAC based on the user authentication key and the temporary UE ID. Input parameters to the integrity algorithm may include the user authentication key, the temporary UE ID (e.g., selected from a C-RNTI), a PQC-C-RNTI, and a pseudo random (PR)-C-RNTI. In some cases, the input parameters may additionally include the DCI or the encrypted DCI. The PQC-C-RNTI may be determined based on PWC encryption of the C-RNTI of the UE, and the PR-C-RNTI may be generated based on an output of a pseudo-random sequence generator that is initialized based on the C-RNTI and a configured parameter, pdcch-ScramblingID1. In some examples, the UAC may also be based on the DCI or the encrypted DCI, where the UAC may provide integrity check of the DCI or the encrypted DCI in addition to an indication of the intended UE.

Alternatively, the UAC generator may be equipped with a hash function, such as an SHA, or a post-quantum safe hashing alternative. In such cases, the NE may use the UAC generator to generate the UAC based on the temporary UE ID. Input parameters to the hash function may include at least the temporary ID selected from a C-RNTI, a PQC-C-RNTI, and a PR-C-RNTI. In some cases, the input parameters may additionally include the DCI or the encrypted DCI. In some examples, the UAC may also be based on the DCI or the encrypted DCI.

In some implementations, the UAC may be based on timing information such as one or more of a frame, subframe, slot, or symbol index. Additionally, or alternatively, the UAC may be based on search space information (i.e., included in the search space configuration), such as one or more of a search space ID or index, a PMO index, or a lowest CCE index for the PDCCH. Such information may enable a UAC intended for a particular UE to change dynamically, which may provide additional privacy protection for the PDCCH. For a UE-specific PDCCH search space set, search space information may include UE-specific information that is communicated (e.g., transmitted, signaled) to the UE with privacy and integrity protection. As such, a UAC generated based on UE-specific search space information may provide enhanced privacy protection compared to a UAC that is generated based on cell-specific timing information.

In some cases, the UAC may be the same for any PDCCH candidate in a particular search space, aggregation level, or PMO within a time-domain container (e.g., frame, subframe, slot, set of symbols, and so forth), independent of payload contents (e.g., DCI, CRC bits, or both). In some examples, CRC parity bits may be calculated based on the DCI and attached to the DCI before encryption, where the DCI and the CRC bits may be encrypted. The UAC may be attached to the encrypted DCI and CRC to form information bits, as depicted in the flow diagram 200.

In some examples, the UE may receive information regarding (e.g., an indication of) a temporary UE ID, a cipher key, an integrity protection key, and a user authentication key with privacy and integrity protection. For example, after security context for the UE is established and enabled, the UE may receive the information via an encrypted and integrity protected NAS message, an encrypted and integrity protected RRC, or an encrypted and integrity protected MAC-CE. In some examples, the temporary UE ID may include a C-RNTI of 16 bits or PQC-C-RNTI, which may an output of a PQC encryption function and is longer than a C-RNTI. Additionally, the UE may receive at least one PDCCH search space configuration, where each search space configuration may define at least one or more of an associated CORESET, a monitoring pattern periodicity, one or more monitoring occasions or slots within a monitoring period, a number of PDCCH candidates in each CCE aggregation level, and one or more associated DCI formats. For a given PDCCH candidate in a configured search space set, the UE may perform demodulation on REs corresponding to the PDCCH candidate, descrambles channel bits resulting from the demodulation, and decodes the descrambled channel bits. For demodulation on the resource elements of the PDCCH candidate, the UE may utilize DMRS REs.

If the NE generates and attaches a UAC to DCI, the UE may extract the UAC from the decoded bits. The UE may identify whether the received UAC is intended for the UE by checking whether an expected UAC generated by the UE matches with the received UAC. The UE may generate the expected UAC according to a specified UAC generation method, as described herein. In response to confirming that the UAC is intended for the UE, the UE may decrypt the DCI based on the cipher key if the DCI is ciphered. Alternatively, the UE may decrypt the DCI first and then generate an expected UAC based on the decrypted DCI. In such cases, the expected UAC is used to verify an intended UE of the PDCCH candidate and the integrity of the received DCI.

In some examples, the UE may receive an indication of whether the NE applied encryption, ciphering, or integrity protection to the DCI. The UE may receive the indication via a PDCCH configuration, the search space configuration, or both. In some implementations, if the NE calculates CRC parity bits based on the DCI and attaches the CRC parity bits to the DCI before encryption, the UE may decrypt the decoded bits based on the cipher key. In addition, the UE may check whether expected CRC parity bits generated based on the decoded, decrypted DCI bits match the decoded, decrypted CRC parity bits. If the expected CRC parity bits match the received, decoded, and decrypted CRC parity bits, then the UE may consider the DCI as successfully detected or received. Otherwise (e.g., if the expected and received CRC parity bits do not match), the UE may proceed with blind decoding of a different PDCCH candidate.

In some examples, if the NE encrypts the DCI first and then uses the encrypted DCI to calculate the CRC parity bits, the UE may check whether the expected CRC parity bits generated based on the decoded, encrypted DCI bits match the decoded CRC parity bits. If the expected and decoded CRC parity bits, then the UE may decrypt the decoded, encrypted DCI bits.

Alternatively, the NE may refrain from appending the CRC parity bits to the DCI. In such cases, the NE may use DCI or encrypted DCI to generate a UAC, and the UE may perform integrity checking (e.g., authorize the DCI for the UE) based on the UAC. If the NE scrambles CRC parity bits with at least a part of the UAC, the UE may generate an expected UAC and descramble CRC parity bits obtained from the decoded bits with at least a part of the expected UAC. The UE may perform CRC checking based on the descrambled CRC parity bits. If the CRC checking passes, and if another part of the expected UAC matches with a part of the UAC, if any, that is attached to DCI and is obtained from the decoded bits, the UE may consider that the DCI is successfully detected or received. In some examples, the UE may receive information associated with one or more of a scrambling identity and the number of PDCCH monitoring periods within which PMOs or PDCCH monitoring slots are counted or indexed, where the information is used for generating one or more of a DMRS, a scrambling sequence, or the UAC.

By way of example, the flow diagram 200 illustrates an exemplary method for generating a PDCCH and a corresponding DMRS with privacy and integrity protection. In the flow diagram 200, an NE may encrypt both DCI and CRC bits. The NE may also generate a time-varying UAC, which may be dependent on a PMO and the DCI. In some examples, the NE may generate the UAC based on an integrity algorithm with input parameters including one or more of a user authentication key, the encrypted DCI, the encrypted CRC bits, a C-RNTI, or a PMO index corresponding to a PDCCH. A UE may confirm the integrity of the PDCCH by determining that the PDCCH is intended for the UE and that the PDCCH has not been altered by an attacker. The UE may make such determinations if another UAC generated by the UE based on the user authentication key, the decoded encrypted DCI and CRC bits, the C-RNTI, and the PMO index matches with the UAC received by the UE from the NE. That is, integrity protection of the PDCCH may be provided based on the UAC.

As depicted in the flow diagram 200, an initialization parameter set 1 for a pseudo-random sequence generator for a scrambling sequence, and an initialization parameter set 2 for a pseudo-random sequence generator for a DMRS sequence may be selected from an output sequence of a hash function whose input parameters are the C-RNTI and a configured scrambling identity. The output sequence selections for the initialization parameter sets 1 and 2 may be dependent on the PMO index. Reusing the same hash output may reduce computational complexity for hashing. Additionally, selecting initialization parameters from the hash output based on the PMO index may result in time-varying scrambling and DMRS sequences that provide the PDCCH with privacy protection.

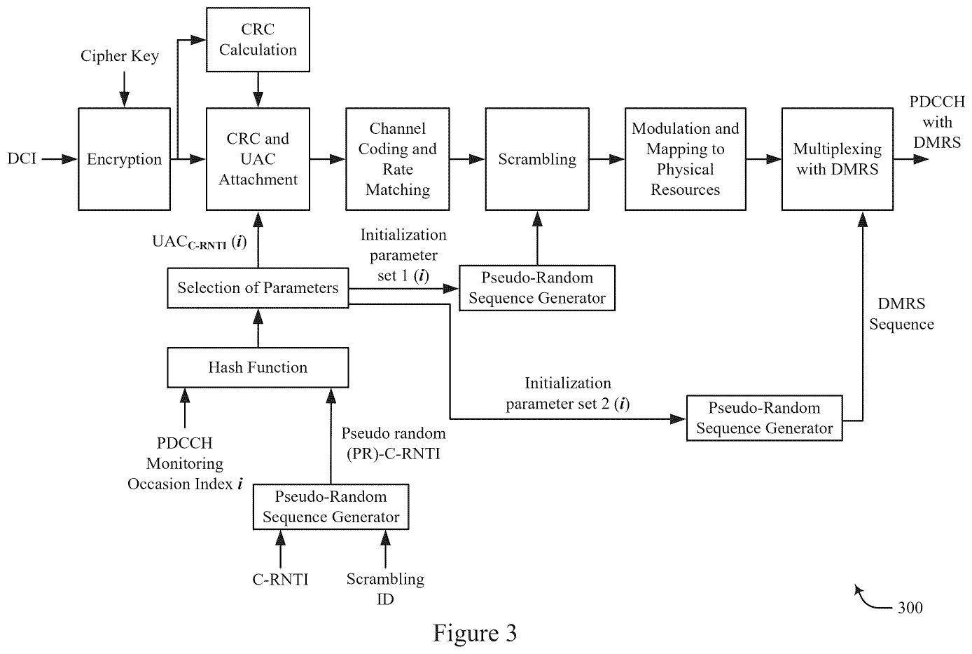

FIG. 3 illustrates an example of a flow diagram 300 in accordance with aspects of the present disclosure. The flow diagram 300 may represent an exemplary method for generating a PDCCH with privacy protection.

As described herein with reference to FIG. 2, DCI may be encrypted based on physical-layer symmetric keys which may be established or shared when higher-layer encryption keys are established. Alternatively, an NE may first encrypt DCI and then use the encrypted DCI to calculate CRC parity bits, as described herein with reference to FIG. 3. In some examples, the NE may append the CRC parity bits and UAC bits (associated with a generated UAC) to the encrypted DCI to form information bits. In some cases, the NE may use at least a portion of the UAC bits to scramble the CRC parity bits. The scrambled CRC parity bits and the remaining UAC bits (i.e., the UAC bits not used for scrambling the CRC parity bits) may be appended to the encrypted DCI to form information bits. For example, the CRC parity bits

$${\{ {b}_{k} \}}_{k = 0}^{k = 23}$$

of the encrypted DCI may be scrambled with the 24 bits x₀, x₁, . . . , x₂₃ of the 32-bit UAC, where x₀ may correspond to a most significant bit (MSB) (or in other examples, a least significant bit (LSB)), to form a sequence of scrambled CRC bits c₀, c₁, c₂, c₃, . . . , c₂₃. The relationship between cₖ and bₖ may be cₖ=(bₖ+xₖ) mod 2 for k=0, 1, 2, . . . , 23.

The information bits may be encoded in a channel coding block and rate-matched to form channel bits. The channel bits may be scrambled with a pseudo-random sequence and then modulated, which may result in a block of complex-valued modulation symbols. The block of complex-valued symbols may be scaled by a factor β_{PDCCH} and mapped to resource elements of a PDCCH. In some examples, the NE may generate a DMRS sequence and map the DMRS sequence to REs multiplexed with the REs of the PDCCH. The NE may transmit the PDCCH with the DMRS to a UE.

In some implementations, the NE may generate the pseudo-random sequence used for scrambling the channel bits (i.e. a scrambling sequence) based on one or more of the temporary UE ID, a configured parameter pdcch-ScramblingID2, and search space information, such as one or more of a search space ID or index, a PMO index, or a lowest CCE index for the PDCCH. Using the search space information enables the scrambling sequence to change over time and/or across PDCCH candidates, which may provide enhanced privacy protection.

In some examples, a block of bits b (0), . . . , b (M_{bit}−1) resulting from encoding may be scrambled prior to modulation, where M_{bit} may represent the number of bits transmitted on the PDCCH. This may result in a block of scrambled bits b (0), . . . , b (M_{bit}−1) according to \tilde{b}(m)=(b(m)+c(m)) mod 2, where c(m) may represent a scrambling sequence (e.g., a pseudo-random sequence defined by a length-31 Gold sequence). A scrambling sequence generator may be initialized with cᵢₙᵢₜ=(n_{ID1}·2¹⁶+n_{ID2})mod 2³¹, where n_{ID1}∈{0, 1, . . . , 65535} and n_{ID2}∈{0, 1, . . . , 65535}, n_{ID1} may represent a value determined by 16 bits xₒ₁₍ᵢ₎, xₒ₁₍ᵢ₎₊₁, . . . , xₒ₁₍ᵢ₎₊₁₅ from an output sequence of hashing of a C-RNTI and the configured parameter pdcch-ScramblingID2, and n_{ID2} may represent a value determined by another 16 bits xₒ₂₍ᵢ₎, xₒ₂₍ᵢ₎₊₁, . . . , xₒ₂₍ᵢ₎₊₁₅ from the output sequence of hashing of the C-RNTI and the configured parameter pdcch-ScramblingID2. The two distinct bit position offsets O₁(i) and O₂(i) may be determined based on a PMO index i within a configured number of PDCCH monitoring periods.

In some implementations, the NE may generate a DMRS corresponding to the PDCCH based on one or more of the temporary UE ID, a configured parameter pdcch-ScramblingID2, or search space information, such as one or more of a search space ID or index, a PMO index, or a lowest CCE index for the PDCCH. In some examples, the UE may assume a reference-signal sequence rₗ(m) for OFDM symbol l is defined by

$${r}_{l} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) ,$$

where c(m) may represent a pseudo-random sequence defined by a length-31 Gold sequence. The pseudo-random sequence generator may be initialized with

$${c}_{i n i t} = ( {2}^{17} ( {N}_{s y m b}^{slot} {n}_{s , f}^{μ} + l + 1 ) ( 2 {N}_{ID} + 1 ) + 2 {N}_{ID} ) mod {2}^{31} ,$$

where l may represent the OFDM symbol number within the slot,

$${n}_{s , f}^{μ}$$

may represent the slot number within a frame, and N_{ID}∈{0, 1, . . . , 65535} may be given by a value determined by 16 bits xₒ₃₍ᵢ₎, xₒ₃₍ᵢ₎₊₁, . . . , xₒ₃₍ᵢ₎₊₁₅ from an output sequence of hashing of a C-RNTI and a configured parameter pdcch-ScramblingID2. The bit position offset O₃(i) may be determined based on a PMO index i within a configured number of PDCCH monitoring periods. In some examples, the NE may transmit information regarding at least one scrambling identity and a number of PDCCH monitoring periods within which PMOs or PDCCH monitoring slots may be counted or indexed.

By way of example, the flow diagram 300 illustrates an exemplary method for generating a PDCCH and a corresponding DMRS with privacy protection. According to the flow diagram 300, the NE may encrypt DCI and compute CRC based on the encrypted DCI. A pseudo-random sequence generator initialized based on a C-RNTI and a configured scrambling identity may generate a PR-C-RNTI. The NE may select a UAC, an initialization parameter set 1 (for generating a scrambling sequence), and an initialization parameter set 2 (for generating a DMRS sequence) from an output sequence of a hash function whose input parameters are PR-C-RNTI and a PMO index. Since the output sequence of the hash function may depend on the PMO index, the NE may generate the time-varying UAC, the scrambling sequence, and the DMRS sequence, which may provide privacy protection for a PDCCH. Additionally, a UE may generate an expected UAC, the scrambling sequence, and the DMRS sequence based on the C-RNTI, the configured scrambling identity, and the PMI index. The UE may perform demodulation based on the DMRS sequence, descramble channel bits using the scrambling sequence, decode the descrambled channel bits, and determine whether the PDCCH is intended for the UE based on the expected UAC and the decoded bits.

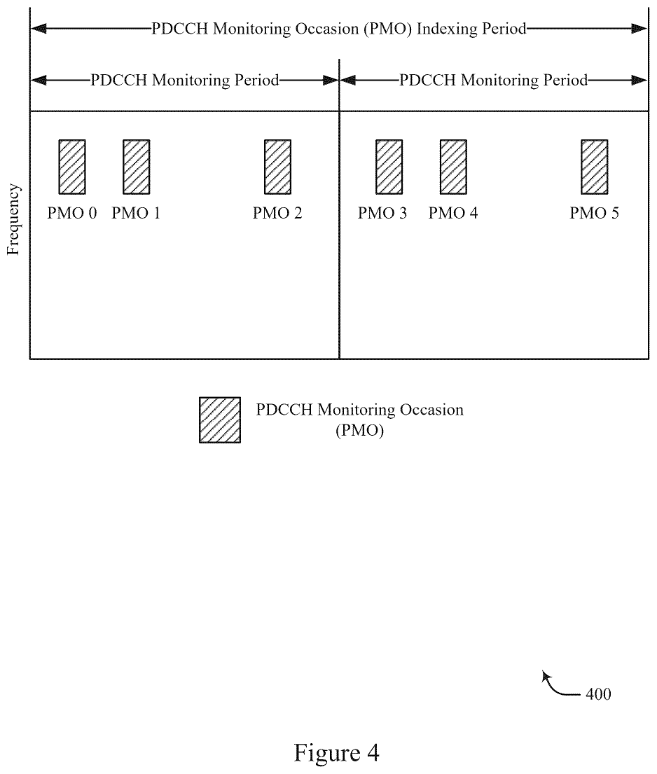

FIG. 4 illustrates an example of a PMO configuration 400 in accordance with aspects of the present disclosure. The PMO configuration 400 includes a configuration of various PMOs and corresponding indexing in an exemplary search space configuration. In each PDCCH monitoring period, three PMOs may be configured, and the PMOs may be indexed within every two PDCCH monitoring periods. For example, a PMO 0, a PMO 1, and a PMO 2 may be configured in a first PDCCH monitoring period, and a PMO 3, a PMO 4, and a PMO 5 may be configured in a second PDCCH monitoring period, where the first and second PDCCH monitoring periods are within a PMO indexing period.

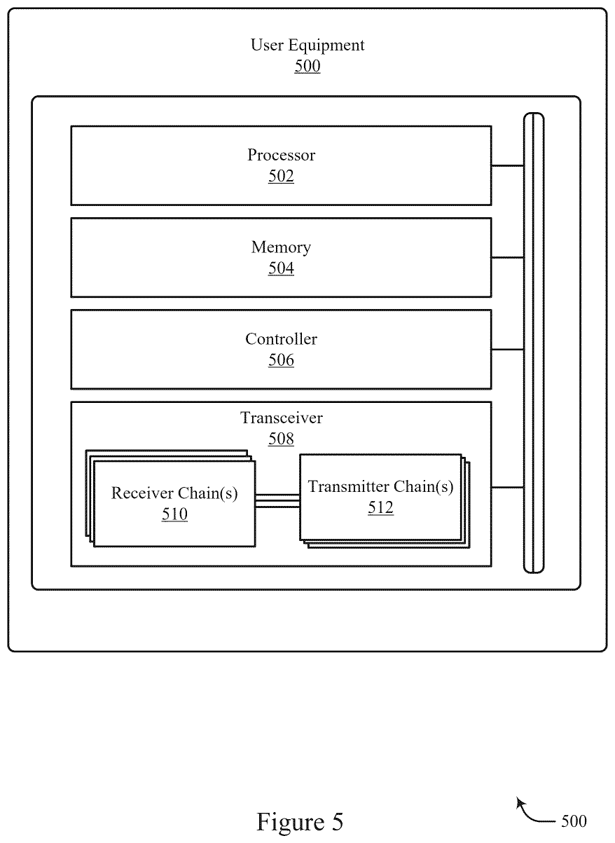

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving information indicating a temporary UE ID and at least one search space configuration; decoding one or more channel bits associated with a PDCCH candidate of a search space set, where the search space set corresponds to at least one search space configuration; and authenticating the PDCCH candidate for the UE based on an expected UAC and the decoded channel bits, wherein the expected UAC is based on the temporary UE ID. In this manner, the UE 500 supports PDCCH verification and authentication (e.g., integrity checking) based on a UAC, which enhances privacy protection for the PDCCH.

Additionally, or alternatively, the UE 500 may be configured to or operable to support any one or combination of the following. For example, the UE 500 may be configured to or operable to support generating an expected UAC based on the temporary UE ID. This aspect enhances privacy protection for the PDCCH by updating the expected UAC for each temporary UE ID. Additionally, or alternatively, the UE 500 may be configured to or operable to support where the information further indicates a cipher key, and decrypting encrypted DCI associated with the decoded channel bits based on the cipher key. This aspect ensures that the UE decrypts encrypted DCI based on a cipher key indicated to that particular UE, improving privacy and integrity protection for the UE 500.

Additionally, or alternatively, the UE 500 may be configured to or operable to support identifying a UAC based on the decoded channel bits, and verifying that the expected UAC matches the identified UAC, where the encrypted DCI is decrypted based on the expected UAC matching the identified UAC. This aspect improves privacy and integrity protection by the UE 500 by verifying that a PDCCH is intended for the UE 500 based on UACs.

Additionally, or alternatively, the UE 500 may be configured to or operable to support generating the expected UAC based on the encrypted DCI, and verifying the encrypted DCI based on the expected UAC and the identified UAC. This aspect improves privacy and integrity protection by the UE 500 by verifying that a PDCCH is intended for the UE 500 based on UACs.

Additionally, or alternatively, the UE 500 may be configured to or operable to support generating the expected UAC based on the decrypted DCI, and verifying the decrypted DCI based on the expected UAC and a UAC identified based on decryption of the decoded channel bits. This aspect improves privacy and integrity protection by the UE 500 by verifying that a PDCCH is intended for the UE 500 based on UACs.

Additionally, or alternatively, the UE 500 may be configured to or operable to support decrypting one or more CRC bits associated with the encrypted DCI, generating one or more expected CRC bits based on the decrypted DCI, and determining whether the DCI is successfully detected based on the expected CRC bits, the decrypted CRC bits, and a determination that the PDCCH candidate is authenticated for the UE. This aspect improves privacy and security protection of the PDCCH by enabling the UE 500 to determine whether a DCI is successfully detected based on verifying that an associated PDCCH is intended for the UE 500.

Additionally, or alternatively, the UE 500 may be configured to or operable to support identifying one or more CRC bits from the decoded channel bits based on descrambling at least a portion of the decoded channel bits of a first length with at least a portion of the expected UAC of the first length, generating one or more expected CRC bits based on the encrypted DCI, and determining whether the DCI is successfully detected based on the expected CRC bits and the identified CRC bits. This aspect improves privacy and security protection of the PDCCH by enabling the UE 500 to determine whether a DCI is successfully detected based on a CRC.

Additionally, or alternatively, the UE 500 may be configured to or operable to support the information further indicating a user authentication key, and generating the expected UAC based on the temporary UE ID and the user authentication key. This aspect further supports PDCCH verification and authentication based on a user authentication key.

Additionally, or alternatively, the UE 500 may be configured to or operable to support generating the expected UAC based on search space-related information included in the at least one search space configuration, where the search space-related information includes one or more of a search space identity, a PMO index, or a lowest CCE index for the PDCCH candidate. This aspect enables the UAC intended to the UE 500 to change dynamically, which provides additional privacy protection for the PDCCH.

Additionally, or alternatively, the UE 500 may be configured to or operable to support demodulating one or more REs corresponding to the PDCCH candidate based on one or more DMRS REs and a DMRS sequence associated with the PDCCH candidate, where the DMRS sequence is based on one or more of a hashing function, the temporary UE ID, a scrambling identity, or search space-related information included in the at least one search space configuration. This aspect provides additional privacy protection for the PDCCH by basing a DMRS sequence on various factors.

Additionally, or alternatively, the UE 500 may be configured to or operable to support descrambling the one or more channel bits according to a scrambling sequence, where the scrambling sequence is based on one or more of a hashing function, the temporary UE ID, a scrambling identity, or search space-related information included in the at least one search space configuration, and where decoding the one or more channel bits includes decoding the descrambled channel bits. This aspect provides additional privacy protection for the PDCCH as the output sequence of the hash function is dependent on the PMO index, resulting in the time-varying UAC, scrambling sequence, and DMRS sequence.

Additionally, or alternatively, the UE 500 may be configured to or operable to support the information being received via one or more of an encrypted and integrity-protected NAS message, an encrypted and integrity-protected RRC message, or an encrypted and integrity-protected MAC-CE. This aspect improves signaling security and reduces vulnerability of PDCCH transmissions.

Additionally, or alternatively, the UE 500 may support at least one memory (e.g., the memory 504) and at least one processor (e.g., the processor 502) coupled with the at least one memory and configured to cause the UE to receive information indicating a temporary UE ID and at least one search space configuration; decode one or more channel bits associated with a PDCCH candidate of a search space set, where the search space set corresponds to the at least one search space configuration; and authenticate the PDCCH candidate for the UE based on an expected UAC and the decoded channel bits, where the expected UAC is based on the temporary UE ID. In this manner, the UE 500 supports PDCCH verification and authentication (e.g., integrity checking) based on a UAC, which enhances privacy protection for the PDCCH.

Additionally, or alternatively, the UE 500 may be configured to or operable to support any one or combination of the following. For example, the UE 500 may be configured to or operable to support generating an expected UAC based on the temporary UE ID. This aspect enhances privacy protection for the PDCCH by updating the expected UAC for each temporary UE ID. Additionally, or alternatively, the UE 500 may be configured to or operable to support where the information further indicates a cipher key, and decrypting encrypted DCI associated with the decoded channel bits based on the cipher key. This aspect ensures that the UE decrypts encrypted DCI based on a cipher key indicated to that particular UE, improving privacy and integrity protection for the UE 500.

Additionally, or alternatively, the UE 500 may be configured to or operable to support identifying a UAC based on the decoded channel bits, and verifying that the expected UAC matches the identified UAC, where the encrypted DCI is decrypted based on the expected UAC matching the identified UAC. This aspect improves privacy and integrity protection by the UE 500 by verifying that a PDCCH is intended for the UE 500 based on UACs.

Additionally, or alternatively, the UE 500 may be configured to or operable to support generating the expected UAC based on the encrypted DCI, and verifying the encrypted DCI based on the expected UAC and the identified UAC. This aspect improves privacy and integrity protection by the UE 500 by verifying that a PDCCH is intended for the UE 500 based on UACs.

Additionally, or alternatively, the UE 500 may be configured to or operable to support generating the expected UAC based on the decrypted DCI, and verifying the decrypted DCI based on the expected UAC and a UAC identified based on decryption of the decoded channel bits. This aspect improves privacy and integrity protection by the UE 500 by verifying that a PDCCH is intended for the UE 500 based on UACs.

Additionally, or alternatively, the UE 500 may be configured to or operable to support decrypting one or more CRC bits associated with the encrypted DCI, generating one or more expected CRC bits based on the decrypted DCI, and determining whether the DCI is successfully detected based on the expected CRC bits, the decrypted CRC bits, and a determination that the PDCCH candidate is authenticated for the UE. This aspect improves privacy and security protection of the PDCCH by enabling the UE 500 to determine whether a DCI is successfully detected based on verifying that an associated PDCCH is intended for the UE 500.

Additionally, or alternatively, the UE 500 may be configured to or operable to support identifying one or more CRC bits from the decoded channel bits based on descrambling at least a portion of the decoded channel bits of a first length with at least a portion of the expected UAC of the first length, generating one or more expected CRC bits based on the encrypted DCI, and determining whether the DCI is successfully detected based on the expected CRC bits and the identified CRC bits. This aspect improves privacy and security protection of the PDCCH by enabling the UE 500 to determine whether a DCI is successfully detected based on a CRC.

Additionally, or alternatively, the UE 500 may be configured to or operable to support the information further indicating a user authentication key, and generating the expected UAC based on the temporary UE ID and the user authentication key. This aspect further supports PDCCH verification and authentication based on a user authentication key.

Additionally, or alternatively, the UE 500 may be configured to or operable to support generating the expected UAC based on search space-related information included in the at least one search space configuration, where the search space-related information includes one or more of a search space identity, a PMO index, or a lowest CCE index for the PDCCH candidate. This aspect enables the UAC intended to the UE 500 to change dynamically, which provides additional privacy protection for the PDCCH.

Additionally, or alternatively, the UE 500 may be configured to or operable to support demodulating one or more REs corresponding to the PDCCH candidate based on one or more DMRS REs and a DMRS sequence associated with the PDCCH candidate, where the DMRS sequence is based on one or more of a hashing function, the temporary UE ID, a scrambling identity, or search space-related information included in the at least one search space configuration. This aspect provides additional privacy protection for the PDCCH by basing a DMRS sequence on various factors.

Additionally, or alternatively, the UE 500 may be configured to or operable to support descrambling the one or more channel bits according to a scrambling sequence, where the scrambling sequence is based on one or more of a hashing function, the temporary UE ID, a scrambling identity, or search space-related information included in the at least one search space configuration, and where decoding the one or more channel bits includes decoding the descrambled channel bits. This aspect provides additional privacy protection for the PDCCH as the output sequence of the hash function is dependent on the PMO index, resulting in the time-varying UAC, scrambling sequence, and DMRS sequence.

Additionally, or alternatively, the UE 500 may be configured to or operable to support the information being received via one or more of an encrypted and integrity-protected NAS message, an encrypted and integrity-protected RRC message, or an encrypted and integrity-protected MAC-CE. This aspect improves signaling security and reduces vulnerability of PDCCH transmissions.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to or operable to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

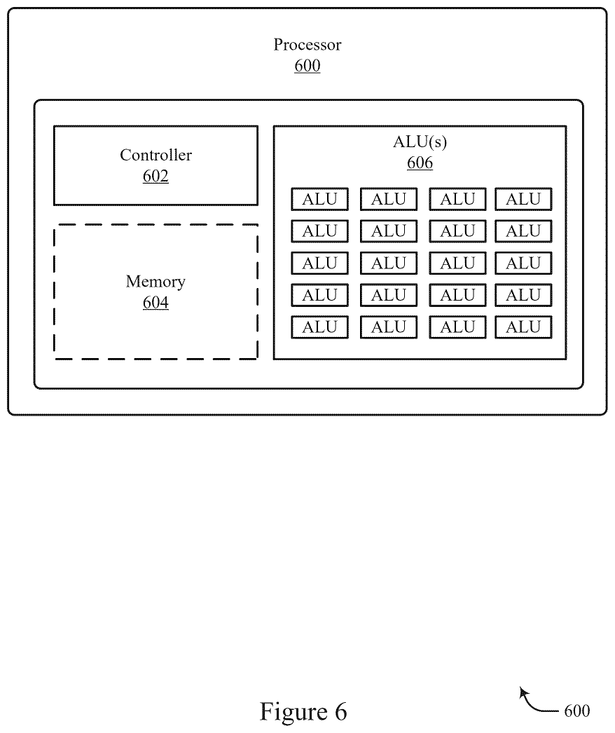

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to or operable to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive information indicating a temporary UE ID and at least one search space configuration; decode one or more channel bits associated with a PDCCH candidate of a search space set, where the search space set corresponds to the at least one search space configuration; and authenticate the PDCCH candidate for the UE based on an expected UAC and the decoded channel bits, where the expected UAC is based on the temporary UE ID. In this manner, the processor 600 supports PDCCH verification and authentication (e.g., integrity checking) based on a UAC, which enhances privacy protection for the PDCCH.

Additionally, or alternatively, the processor 600 may be configured to or operable to support any one or combination of the following. For example, the processor 600 may be configured to or operable to support generating the expected UAC based on the temporary UE ID. This aspect further supports PDCCH verification and authentication based on a user authentication key.

Additionally, or alternatively, the processor 600 may be configured to or operable to support where the information further indicates a cipher key, and decrypting encrypted DCI associated with the decoded channel bits based on the cipher key. This aspect ensures that the UE decrypts encrypted DCI based on a cipher key indicated to that particular UE, improving privacy and integrity protection.

Additionally, or alternatively, the processor 600 may be configured to or operable to support identifying a UAC based on the decoded channel bits, and verifying that the expected UAC matches the identified UAC, where the encrypted DCI is decrypted based on the expected UAC matching the identified UAC. This aspect improves privacy and integrity protection by the processor 600 by verifying that a PDCCH is intended for the processor 600 based on UACs.

Additionally, or alternatively, the processor 600 may be configured to or operable to support generating the expected UAC based on the encrypted DCI, and verifying the encrypted DCI based on the expected UAC and the identified UAC. This aspect improves privacy and integrity protection by the processor 600 by verifying that a PDCCH is intended for the processor 600 based on UACs.

Additionally, or alternatively, the processor 600 may be configured to or operable to support generating the expected UAC based on the decrypted DCI, and verifying the decrypted DCI based on the expected UAC and a UAC identified based on decryption of the decoded channel bits. This aspect improves privacy and integrity protection by the processor 600 by verifying that a PDCCH is intended for the processor 600 based on UACs.

Additionally, or alternatively, the processor 600 may be configured to or operable to support decrypting one or more CRC bits associated with the encrypted DCI, generating one or more expected CRC bits based on the decrypted DCI, and determining whether the DCI is successfully detected based on the expected CRC bits, the decrypted CRC bits, and a determination that the PDCCH candidate is authenticated for the UE. This aspect improves privacy and security protection of the PDCCH by enabling the processor 600 to determine whether a DCI is successfully detected based on verifying that an associated PDCCH is intended for the processor 600.

Additionally, or alternatively, the processor 600 may be configured to or operable to support identifying one or more CRC bits from the decoded channel bits based on descrambling at least a portion of the decoded channel bits of a first length with at least a portion of the expected UAC of the first length, generating one or more expected CRC bits based on the encrypted DCI, and determining whether the DCI is successfully detected based on the expected CRC bits and the identified CRC bits. This aspect improves privacy and security protection of the PDCCH by enabling the processor 600 to determine whether a DCI is successfully detected based on a CRC.

Additionally, or alternatively, the processor 600 may be configured to or operable to support the information further indicating a user authentication key, and generating the expected UAC based on the temporary UE ID and the user authentication key. This aspect further supports PDCCH verification and authentication based on a user authentication key.

Additionally, or alternatively, the processor 600 may be configured to or operable to support generating the expected UAC based on search space-related information included in the at least one search space configuration, where the search space-related information includes one or more of a search space identity, a PMO index, or a lowest CCE index for the PDCCH candidate. This aspect enables the UAC intended to the processor 600 to change dynamically, which provides additional privacy protection for the PDCCH.

Additionally, or alternatively, the processor 600 may be configured to or operable to support demodulating one or more REs corresponding to the PDCCH candidate based on one or more DMRS REs and a DMRS sequence associated with the PDCCH candidate, where the DMRS sequence is based on one or more of a hashing function, the temporary UE ID, a scrambling identity, or search space-related information included in the at least one search space configuration. This aspect provides additional privacy protection for the PDCCH by basing a DMRS sequence on various factors.

Additionally, or alternatively, the processor 600 may be configured to or operable to support descrambling the one or more channel bits according to a scrambling sequence, where the scrambling sequence is based on one or more of a hashing function, the temporary UE ID, a scrambling identity, or search space-related information included in the at least one search space configuration, and where decoding the one or more channel bits includes decoding the descrambled channel bits. This aspect provides additional privacy protection for the PDCCH as the output sequence of the hash function is dependent on the PMO index, resulting in the time-varying UAC, scrambling sequence, and DMRS sequence.

Additionally, or alternatively, the processor 600 may be configured to or operable to support the information being received via one or more of an encrypted and integrity-protected NAS message, an encrypted and integrity-protected RRC message, or an encrypted and integrity-protected MAC-CE. This aspect improves signaling security and reduces vulnerability of PDCCH transmissions.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to transmit information indicating a temporary UE ID and at least one search space configuration; and transmit a PDCCH associated with DCI and a UAC on one or more REs corresponding to a PDCCH candidate of a search space set, where the search space set corresponds to the at least one search space configuration, and where the UAC is based on the temporary UE ID. In this manner, the processor 600 supports PDCCH verification and authentication (e.g., integrity checking) based on a UAC, which enhances privacy protection for the PDCCH.

Additionally, or alternatively, the processor 600 may be configured to or operable to support any one or combination of the following. For example, the processor 600 may be configured to or operable to support where the information further indicates a cipher key, and encrypting the DCI based on the cipher key. This aspect improves privacy and integrity protection by indicating a particular cipher key which a UE may use to decrypt encrypted DCI.

Additionally, or alternatively, the processor 600 may be configured to or operable to support generating one or more CRC bits associated with the DCI, and encrypting the one or more CRC bits. This aspect improves privacy and integrity protection by utilizing encrypted CRC bits to protect a DCI associated with a PDCCH.

Additionally, or alternatively, the processor 600 may be configured to or operable to support where the information further indicates a user authentication key, and where the UAC is generated based on the temporary UE ID and the user authentication key. This aspect further supports PDCCH verification and authentication based on a user authentication key.

Additionally, or alternatively, the processor 600 may be configured to or operable to support where the UAC is generated based on search space-related information included in the at least one search space configuration, where the search space-related information includes one or more of a search space identity, a PMO index, or a lowest CCE index for the PDCCH candidate. This aspect provides additional privacy protection for the PDCCH as the output sequence of the hash function is dependent on the PMO index, resulting in the time-varying UAC, scrambling sequence, and DMRS sequence.

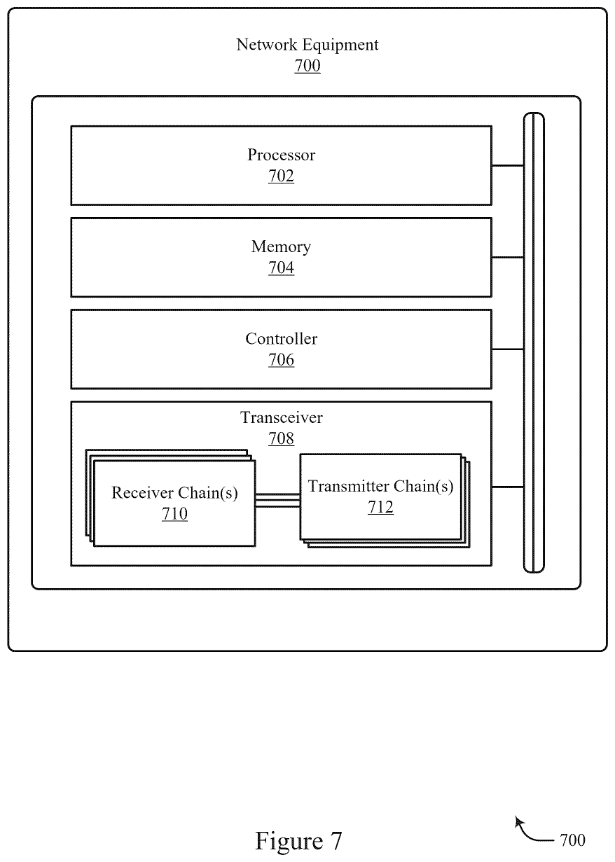

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting information indicating a temporary UE ID and at least one search space configuration; and transmitting a PDCCH associated with DCI and a UAC on one or more REs corresponding to a PDCCH candidate of a search space set, where the search space set corresponds to the at least one search space configuration, and where the UAC is based on the temporary UE ID. In this manner, the NE 700 supports PDCCH verification and authentication (e.g., integrity checking) based on a UAC, which enhances privacy protection for the PDCCH.

Additionally, or alternatively, the NE 700 may be configured to or operable to support any one or combination of the following. For example, the NE 700 may be configured or operable to support where the information further indicates a cipher key, and encrypting the DCI based on the cipher key. This aspect improves privacy and integrity protection by indicating a particular cipher key which a UE may use to decrypt encrypted DCI.

Additionally, or alternatively, the NE 700 may be configured to or operable to support generating one or more CRC bits associated with the DCI, and encrypting the one or more CRC bits. This aspect improves privacy and integrity protection by utilizing encrypted CRC bits to protect a DCI associated with a PDCCH.

Additionally, or alternatively, the NE 700 may be configured to or operable to support where the information further indicates a user authentication key, and where the UAC is generated based on the temporary UE ID and the user authentication key. This aspect further supports PDCCH verification and authentication based on a user authentication key.

Additionally, or alternatively, the NE 700 may be configured to or operable to support where the UAC is generated based on search space-related information included in the at least one search space configuration, where the search space-related information includes one or more of a search space identity, a PMO index, or a lowest CCE index for the PDCCH candidate. This aspect provides additional privacy protection for the PDCCH as the output sequence of the hash function is dependent on the PMO index, resulting in the time-varying UAC, scrambling sequence, and DMRS sequence.

Additionally, or alternatively, the NE 700 may support at least one memory (e.g., the memory 704) and at least one processor (e.g., the processor 702) coupled with the at least one memory and configured to cause the NE to transmit information indicating a temporary UE ID and at least one search space configuration; and transmit a PDCCH associated with DCI and a UAC on one or more REs corresponding to a PDCCH candidate of a search space set, where the search space set corresponds to the at least one search space configuration, and where the UAC is based on the temporary UE ID. In this manner, the NE 700 supports PDCCH verification and authentication (e.g., integrity checking) based on a UAC, which enhances privacy protection for the PDCCH.

Additionally, or alternatively, the NE 700 may be configured to or operable to support any one or combination of the following. For example, the NE 700 may be configured or operable to support where the information further indicates a cipher key, and encrypting the DCI based on the cipher key. This aspect improves privacy and integrity protection by indicating a particular cipher key which a UE may use to decrypt encrypted DCI.

Additionally, or alternatively, the NE 700 may be configured to or operable to support generating one or more CRC bits associated with the DCI, and encrypting the one or more CRC bits. This aspect improves privacy and integrity protection by utilizing encrypted CRC bits to protect a DCI associated with a PDCCH.

Additionally, or alternatively, the NE 700 may be configured to or operable to support where the information further indicates a user authentication key, and where the UAC is generated based on the temporary UE ID and the user authentication key. This aspect further supports PDCCH verification and authentication based on a user authentication key.

Additionally, or alternatively, the NE 700 may be configured to or operable to support where the UAC is generated based on search space-related information included in the at least one search space configuration, where the search space-related information includes one or more of a search space identity, a PMO index, or a lowest CCE index for the PDCCH candidate. This aspect provides additional privacy protection for the PDCCH as the output sequence of the hash function is dependent on the PMO index, resulting in the time-varying UAC, scrambling sequence, and DMRS sequence.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

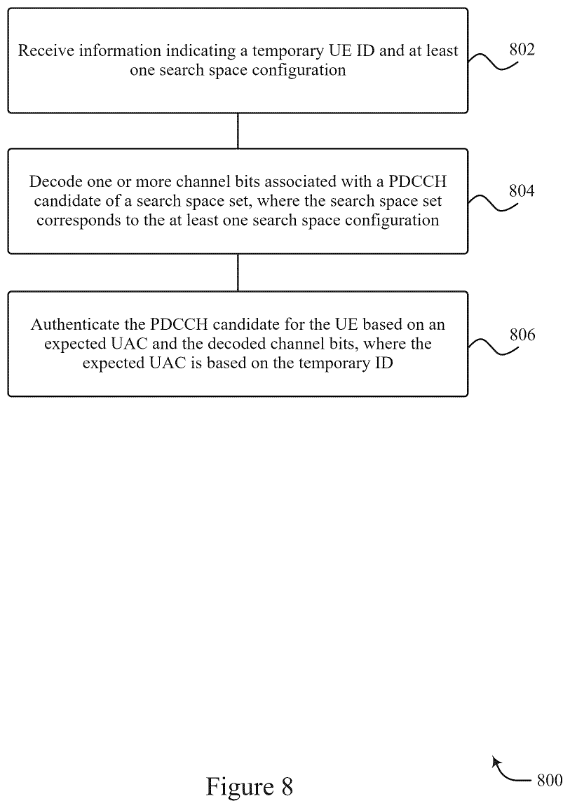

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving information indicating a temporary UE ID and at least one search space configuration. The operations of 802 may be performed in accordance with examples as described herein. In some implementations, aspects of the operations of 802 may be performed by a UE as described with reference to FIG. 5.

At 804, the method may include demodulating one or more REs corresponding to a PDCCH candidate of a search space set, the search space set corresponding to the at least one search space configuration. The operations of 804 may be performed in accordance with examples as described herein. In some implementations, aspects of the operations of 804 may be performed by a UE as described with reference to FIG. 5.

At 806, the method may include decoding one or more channel bits associated with the PDCCH candidate based on the demodulation of the one or more REs. The operations of 806 may be performed in accordance with examples as described herein. In some implementations, aspects of the operations of 806 may be performed by a UE as described with reference to FIG. 5.

At 808, the method may include generating an expected UAC based on the temporary UE ID. The operations of 808 may be performed in accordance with examples as described herein. In some implementations, aspects of the operations of 808 may be performed by a UE as described with reference to FIG. 5.

At 810, the method may include authenticating the PDCCH candidate for the UE based on the expected UAC and the decoded channel bits. The operations of 810 may be performed in accordance with examples as described herein. In some implementations, aspects of the operations of 810 may be performed by a UE as described with reference to FIG. 5.

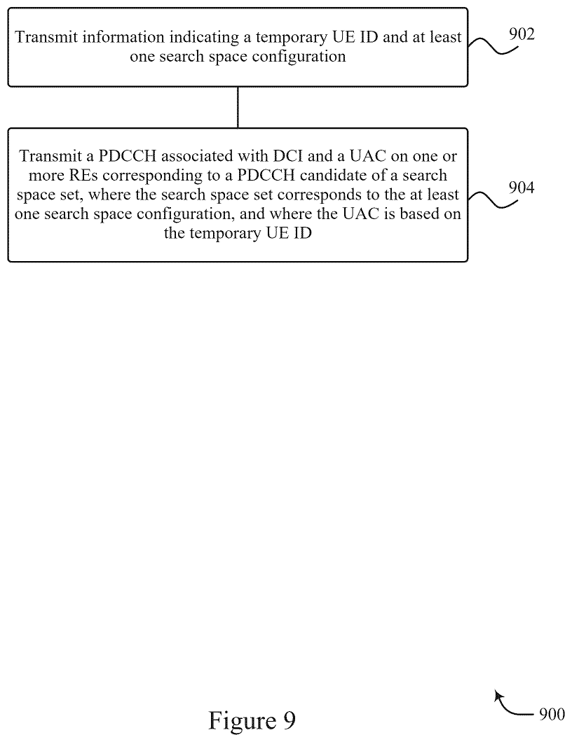

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting information indicating a temporary UE ID and at least one search space configuration. The operations of 902 may be performed in accordance with examples as described herein. In some implementations, aspects of the operations of 902 may be performed by an NE as described with reference to FIG. 7.

At 904, the method may include generating a UAC based on the temporary UE ID. The operations of 904 may be performed in accordance with examples as described herein. In some implementations, aspects of the operations of 904 may be performed by an NE as described with reference to FIG. 7.

At 906, the method may include transmitting a PDCCH associated with DCI and the UAC on one or more REs corresponding to a PDCCH candidate of a search space set, the search space set corresponding to the at least one search space configuration. The operations of 906 may be performed in accordance with examples as described herein. In some implementations, aspects of the operations of 906 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive information indicating a temporary UE identifier (ID) and at least one search space configuration;
decode one or more channel bits associated with a physical downlink control channel (PDCCH) candidate of a search space set, wherein the search space set corresponds to the at least one search space configuration; and
authenticate the PDCCH candidate for the UE based at least in part on an expected user authentication code (UAC) and the decoded channel bits, wherein the expected UAC is based at least in part on the temporary UE ID.

2. The UE of claim 1, wherein the at least one processor is further operable to cause the UE to generate the expected UAC based at least in part on the temporary UE ID.

3. The UE of claim 1, wherein the information further indicates a cipher key, and wherein the at least one processor is further operable to cause the UE to decrypt encrypted downlink control information (DCI) associated with the decoded channel bits based at least in part on the cipher key.

4. The UE of claim 3, wherein the at least one processor is further operable to cause the UE to:
identify a UAC based at least in part on the decoded channel bits; and
verify that the expected UAC matches the identified UAC, wherein the encrypted DCI is decrypted based at least in part on the expected UAC matching the identified UAC.

5. The UE of claim 4, wherein the at least one processor is further operable to cause the UE to:
generate the expected UAC based at least in part on the encrypted DCI; and
verify the encrypted DCI based at least in part on the expected UAC and the identified UAC.

6. The UE of claim 3, wherein the at least one processor is further operable to cause the UE to:
generate the expected UAC based at least in part on the decrypted DCI; and
verify the decrypted DCI based at least in part on the expected UAC and a UAC identified based at least in part on decryption of the decoded channel bits.

7. The UE of claim 3, wherein, to decrypt the encrypted DCI, the at least one processor is further operable to cause the UE to:
decrypt one or more cyclic redundancy check (CRC) bits associated with the encrypted DCI;
generate one or more expected CRC bits based at least in part on the decrypted DCI; and
determine whether the DCI is successfully detected based at least in part on the expected CRC bits, the decrypted CRC bits, and a determination that the PDCCH candidate is authenticated for the UE.

8. The UE of claim 3, wherein the at least one processor is further operable to cause the UE to:
identify one or more CRC bits from the decoded channel bits based at least in part on descrambling at least a portion of the decoded channel bits of a first length with at least a portion of the expected UAC of the first length;
generate one or more expected CRC bits based at least in part on the encrypted DCI; and
determine whether the DCI is successfully detected based at least in part on the expected CRC bits and the identified CRC bits.

9. The UE of claim 1, wherein the information further indicates a user authentication key, and wherein the at least one processor is further operable to cause the UE to generate the expected UAC based at least in part on the temporary UE ID and the user authentication key.

10. The UE of claim 1, wherein the at least one processor is further operable to cause the UE to generate the expected UAC based at least in part on search space-related information included in the at least one search space configuration, wherein the search space-related information comprises one or more of a search space identity, a PDCCH monitoring occasion index, or a lowest control channel element (CCE) index for the PDCCH candidate.

11. The UE of claim 1, wherein the at least one processor is further operable to cause the UE to demodulate one or more resource elements (REs) corresponding to the PDCCH candidate based at least in part on one or more demodulation reference signal (DMRS) REs and a DMRS sequence associated with the PDCCH candidate, wherein the DMRS sequence is based at least in part on one or more of a hashing function, the temporary UE ID, a scrambling identity, or search space-related information included in the at least one search space configuration.

12. The UE of claim 1, wherein the at least one processor is further operable to cause the UE to descramble the one or more channel bits according to a scrambling sequence, wherein the scrambling sequence is based at least in part on one or more of a hashing function, the temporary UE ID, a scrambling identity, or search space-related information included in the at least one search space configuration, and wherein decoding the one or more channel bits comprises decoding the descrambled channel bits.

13. The UE of claim 1, wherein the information is received via one or more of an encrypted and integrity-protected non-access stratus (NAS) message, an encrypted and integrity-protected radio resource control (RRC) message, or an encrypted and integrity-protected medium access control (MAC) control element (CE).

14. A network equipment (NE) for wireless communication, comprising:
at least one memory; and
at least one processor coupled with the at least one memory and operable to cause the NE to:
transmit information indicating a temporary user equipment (UE) identifier (ID) and at least one search space configuration; and
transmit a physical downlink control channel (PDCCH) associated with downlink control information (DCI) and a user authentication code (UAC) on one or more resource elements (REs) corresponding to a PDCCH candidate of a search space set, wherein the search space set corresponds to the at least one search space configuration, and wherein the UAC is based at least in part on the temporary UE ID.

15. The NE of claim 14, wherein the information further indicates a cipher key, and wherein the at least one processor is further operable to cause the NE to encrypt the DCI based at least in part on the cipher key.

16. The NE of claim 15, wherein, to encrypt the DCI, the at least one processor is further operable to cause the NE to:
generate one or more cyclic redundancy check (CRC) bits associated with the DCI; and
encrypt the one or more CRC bits.

17. The NE of claim 14, wherein the information further indicates a user authentication key, and wherein the UAC is generated based at least in part on the temporary UE ID and the user authentication key.

18. The NE of claim 14, wherein the UAC is generated based at least in part on search space-related information included in the at least one search space configuration, wherein the search space-related information comprises one or more of a search space identity, a PDCCH monitoring occasion index, or a lowest control channel element (CCE) index for the PDCCH candidate.

19. A method performed by a user equipment (UE), the method comprising:
receiving information indicating a temporary UE identifier (ID) and at least one search space configuration;
decoding one or more channel bits associated with a physical downlink control channel (PDCCH) candidate of a search space set, wherein the search space set corresponds to the at least one search space configuration; and
authenticating the PDCCH candidate for the UE based at least in part on an expected user authentication code (UAC) and the decoded channel bits, wherein the expected UAC is based at least in part on the temporary UE ID.

20. A method performed by a network equipment (NE), the method comprising:
transmitting information indicating a temporary user equipment (UE) identifier (ID) and at least one search space configuration; and
transmitting a physical downlink control channel (PDCCH) associated with downlink control information (DCI) and a user authentication code (UAC) on one or more resource elements (REs) corresponding to a PDCCH candidate of a search space set, wherein the search space set corresponds to the at least one search space configuration, and wherein the UAC is based at least in part on the temporary UE ID.
